(19) United States
(12) Patent Application Publication
(10) Pub. No.: US 2020/0065527 A1
(43) Pub. Date: Feb. 27, 2020

(54) VARYING-LAYERED ENCRYPTION

(71) Applicant: Avago Technologies General IP(Singapore) Pte. Ltd., Singapore (SG)

(72) Inventors: Steve Walter RODGERS, San Diego, CA (US); Xuemin CHEN, Rancho Santa Fe, CA (US)

(21) Appl. No.: 16/112,359

(22) Filed: Aug. 24, 2018

(51) Int. Cl. G06F 21/74; G06F 21/72; G06F 21/44; G06F 21/78; H04L 9/06

(52) U.S. Cl. CPC G06F 21/74; G06F 21/72; H04L 9/0631; G06F 21/78; G06F 21/44

(57) ABSTRACT

Implementations provide for a system configured to provide multiple security layers. The system includes a memory device storing instructions and data corresponding to processes. The system includes a first processor associated with a first security layer that is configured to provide first cryptographic information corresponding to the particular application. The system further includes a logical resolution circuit that is configured to receive the first cryptographic information, and provide second cryptographic information based on the first cryptographic information, an indication of an instruction or data, and a process identifier (ID) of the particular application. The system also includes a cryptographic element associated with a second security layer that is configured to decrypt, using the second cryptographic information, encrypted instructions or data corresponding to the particular application. Additionally, the system includes a second processor associated with the second security layer that is configured to receive the decrypted instructions or data for processing.

### TECHNICAL FIELD

The present description relates generally to varying-layered encryption, including varying-layered encryption to isolate and protect system instructions and data.

### BACKGROUND

In a system whereby processor instructions (i.e., processor code) and data are stored in a non-volatile memory, those instructions and data may be stored encrypted for security. However, in a typical system, the instructions being executed from DRAM external to the processor may be in the clear which introduces a potential security risk.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates an example computing environment in accordance with one or more implementations.

FIG. 2 conceptually illustrates different layers of a chain of protection for code and data in accordance with one or more implementations.

FIG. 3 illustrates an example system for providing different layers of instructions and data that are encrypted differently in accordance with one or more implementations.

FIG. 4 illustrates an example system including various components to provide differentiated encryption in accordance with one or more implementations.

FIG. 5 illustrates an example logical resolution function including various components in accordance with one or more implementations.

FIG. 6 conceptually illustrates an example flowchart of a process performed by an electronic device for decrypting instructions and/or data from a trusted application in accordance with some implementations.

FIG. 7 illustrates an electronic system with which one r more implementations of the subject technology may be implemented.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more other implementations. In one or more implementations, structures and components are shown in block diagram form in order to avoid obscuring the concepts of the subject technology.

In some existing systems, “on-the-fly” decryption of instructions and or data may be difficult to consistently achieve. For example, strong encryption can present performance implications, since multiple rounds may be needed to decrypt the data. In addition, the block size of modern cryptographic algorithms may not match the blocksize of the retrieved code or data, and/or encrypting new data to DRAM (in the case of data) may cause issues for some CPU modes, if the size of the data to be written does not match the block size. As mentioned herein, the term “instructions” may refer to code or commands that are sent to a given processor or CPU (e.g., a trusted CPU and/or higher trust CPU as discussed further herein) for execution. As mentioned herein, the term “data” may refer to information (e.g., not a command) sent to the CPU for processing as a result of an executed command (e.g., a read command for data).

On the other hand, not encrypting instructions and/or data stored in DRAM may present vulnerabilities at the system level, since the code may be visible to external agents. In addition, there may be lesser trusted elements within the code which are only prevented from accessing more trusted elements within the code through the use of memory management unit (MMU) protections. These MMU protections may be subject to software or logical attacks that can misconfigure the protections or can otherwise provide a window into executing illegitimate code or exposing secret and/or private data. In addition, the MMU-based protections may only provide a single point of failure.

Implementations of the subject technology provide a system that ma employ encryption of code and data whenever the code/data is held external to the SOC, such as in DRAM and/or external flash, which may facilitate compensating for the aforementioned possible vulnerabilities in MMU-based protection.

The subject technology may also provide differing layers of encryption for different security layers within the device. The differing layers of encryption may protect each layer of security from external probing, while also: 1) preventing lesser-trusted elements of the security chain from viewing the code/data of higher-trust elements, 2) providing isolation between trusted applications (TAs) belonging to different parties so that such TAs do not only rely on the MMU protections, 3) protecting the code/data both stored in external flash and while code/data is being executed from DRAM, and 4) performing separate encryption for code and data.

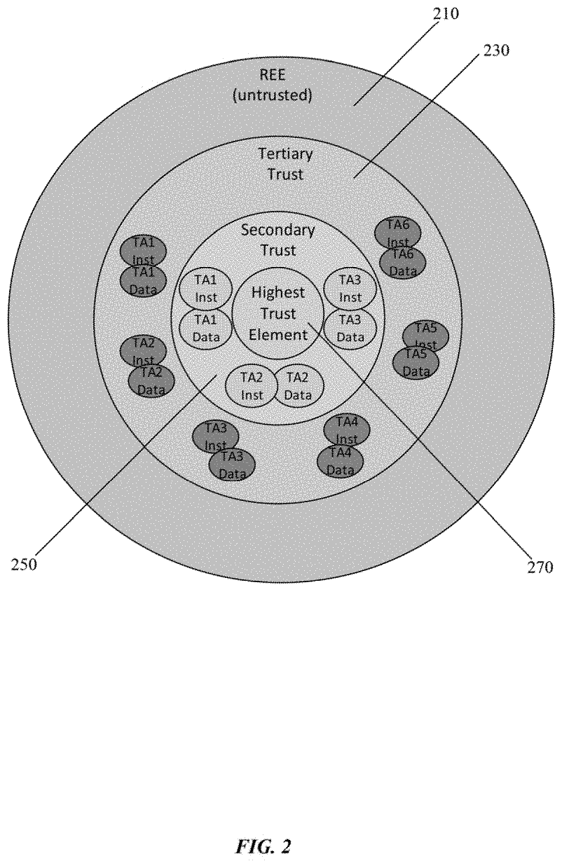

Implementations of the subject technology may also provide differing layers of encryption that may span multiple CPUs involved in the security subsystem and may be controlled by a central “most-trusted” component, which are described in more detail in FIG. 2 below. Thus, different layers of code and data security are protected with different security mechanisms and/or encryptions, with the least secure methods, which may run faster, reserved for the lesser-trusted (or lesser protected) elements and highest cryptographic strength methods, which may run slower, for higher trusted elements. It is appreciated that the subject technology may, however, provide any combination of encryptions and/or security mechanisms.

In addition, implementations of the subject technology may encrypt one or more (or all) stages of CPU data manipulation, e.g., from an initial storage in non-volatile memory (NVM) through instructions encrypted in DRAM, and continuing through intermediate buffers to the final output.

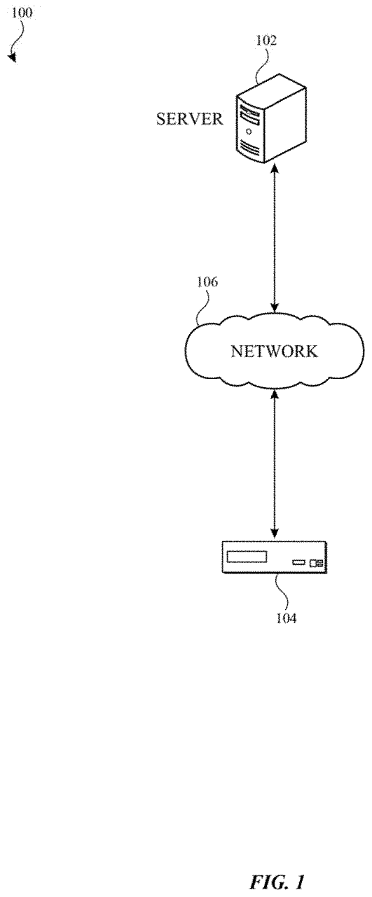

FIG. 1 illustrates an example computing environment 100 in accordance with one or more implementations. Not all of the depicted components may be used, however, and one or more implementations may include additional components not shown in the figure. Variations in the arrangement and type of the components may be made without departing from the spirit or scope of the claims as set forth herein. Additional components, different components, or fewer components may be provided. For example, although a server 102 is provided in the example of FIG. 1, it is appreciated that the server may not be included, and implementations of the subject technology may protect a system with multiple security layers that does not necessarily communicate or interact with a server.

As shown, the computing environment 100 of FIG. 1 includes a server 102, which may be a head end, an electronic device 104, a network 106. The server 102 may be one or more of a satellite communication system based device, a wireless system supported device, or a media-based network supported communication device. The server 102 may be supported by a cable modem network, a telephone network supporting digital subscriber line operations, an optical network, or another type of network having media that couples communications from and to the server 102, or a combination of these. The server 102 may be referred to as a head end, a server computer, a content server, a server provider computer, and/or interchangeably with other descriptions thereof herein. The server 102 includes one or more receivers and decoders, one or more server components, one or more digitized local video sources, software version enforcement functionality, and content protection enforcement functionality.

The server 102 communicatively couples to the network 106. The server 102 may couple to the electronic device 104 via the network 106. Further, the server 102 communicatively couples to the electronic device 104 via the type of communication network, e.g., satellite network, cable modem network, DSL network, optical network, wireless network of a particular service provider. The server 102 may stream content to the electronic device 104 and/or may provide Internet access to the electronic device 104. Further, the server 102 can control the software executed by the electronic device 104.

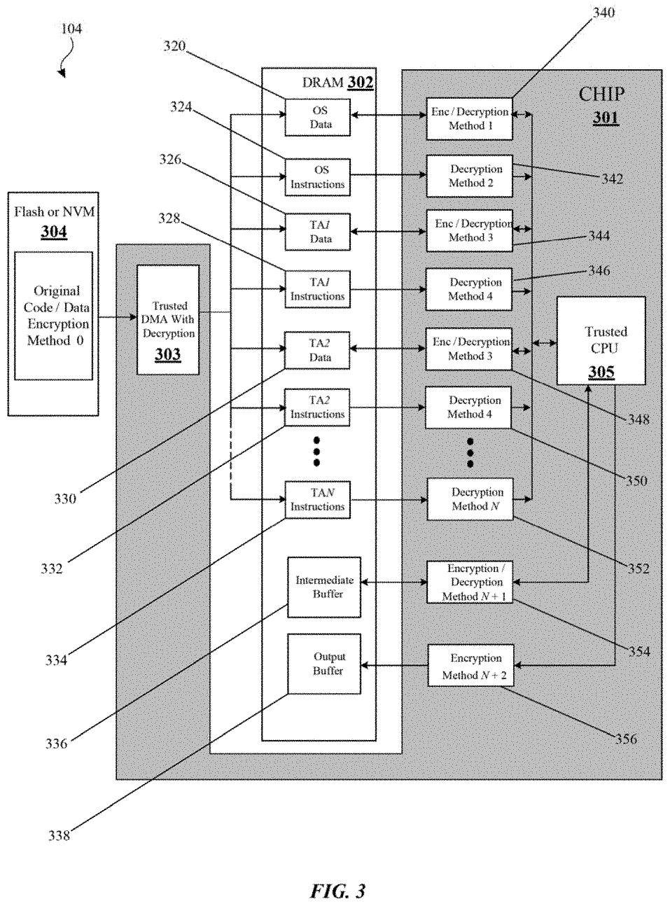

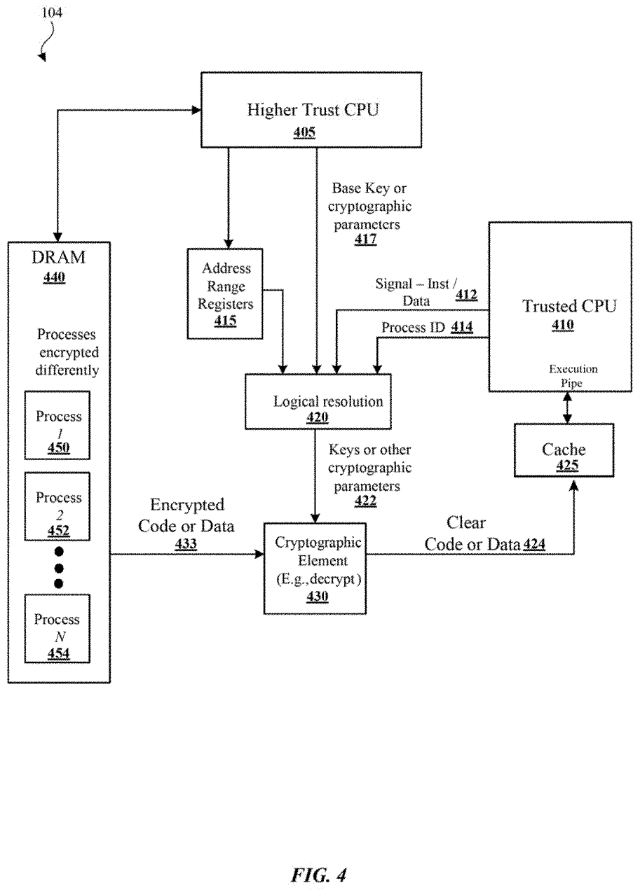

The electronic device 104 includes various components that will be described further herein with reference to FIGS. 3 and 4. The electronic device 104 can couple to one or more of a satellite dish, an antenna, and/or a network interface to support communication with the server 102. The electronic device 104 may include a processor and memory. In an implementation, the processor and the memory may be mounted on a circuit board housed by a set-top box. Although a set-top box is mentioned as an example, it is appreciated that implementations of the subject technology can include any given electronic device that provides multiple security layers as described herein.

The discussion of FIG. 2 below is related to a chain of protection for code and data. As illustrated in FIG. 2, different layers of security instructions and data are shown in different layers, with each element potentially using a different encryption algorithm, a different key, or both. In an example, at the highest trust level (or required protection level), the protected or trusted component may not execute from DRAM, and may only execute from internal SRAM.

FIG. 2 conceptually illustrates different layers of a chain of protection for code and data in accordance with one or more implementations. One or more components of the electronic device 104 as described further herein may implement the different layers illustrated in FIG. 2.

Implementations of the subject technology provide a system that utilizes multiple security rings (or layers), in which each layer may have both lesser trusted and more trusted elements, relative to a central “most-trusted” element, within the layer, which is conceptually illustrated in FIG. 2. For a given user provided with CPUs or trusted applications (TAs) arranged in multiple security layers, the protection level may be ensured by a chain-of-protection for these CPUs or TAs between the security layers. In an example, each higher security layer is responsible for ensuring the protection (i.e., code/data encryption) of lower security layers by writing cryptographic parameters (e.g., keys or other data) to the instruction/data cryptography hardware of the lower trusted component. As a result, no software process in the lower trusted component has access to the knowledge needed to decrypt the code or data within the lower trusted component.

In one or more implementations, each security layer may be encrypted differently from every other layer, each element within a layer may be encrypted differently from each other element, and the instructions and data utilized by the same process may be encrypted differently. As used herein, “encrypted differently” may refer to one or more of the following: 1) different encryption algorithm, 2) different key, 3) different tweak to the same algorithm, 4) different padding, substitution-box, or other cryptographic parameter, or 5) any other difference which produces cryptographically different output for a given input (e.g., using decryption rather than encryption to obscure the clear code).

Further, elements at the same trust level (e.g. separate applications), are prevented, through the use of cryptography, from spying on (e.g., accessing or viewing) the code of other elements. Each element of the system is cryptographically isolated from the others, even those at the same trust level.

As shown, an untrusted layer 210, a tertiary trust layer 230, a secondary trust layer 250, and a highest trust element 270 are included in an implementation of the different layers in the security scheme. In an example, the highest trust element 270 corresponds to a “most-trusted” element in the system. The highest trust element 270 may be implemented as a processor or CPU as described in further detail in FIG. 4 below. In an implementation, the untwisted layer 210 corresponds to a rich execution environment (REE), where the term word “rich” can refer to an operating environment that is feature rich as provided by a modern platform or operating system. Untrusted applications that include unencrypted instructions and unencrypted data, without further verification using cryptography methods in hardware, may execute in the REE provided by the untrusted layer 210.

The tertiary trust layer 230 includes instructions and data from respective trusted applications (TAs) that are associated with the tertiary trust layer 230. Similarly, the secondary trust layer 250 includes instructions and data from respective trusted applications that are associated with the secondary trust layer 250. The highest trust element 270 can control the encryption and decryption of instructions and data for the secondary trust layer 250. In some implementations, a different trust element (e.g., a secondary CPU or processor) than the highest trust element 270 may be provided for the secondary trust layer 250 to enable encryption and decryption of instructions and application code associated with the secondary trust layer 250.

An example system may be implemented as described in the following discussion. A highest security CPU (e.g., highest trust element 270) runs only from internal SRAM or ROM provided by an integrated circuit (IC) chip or a system on a chip (SoC). A secondary security CPU runs from DRAM (e.g., volatile memory device), with encryption that is 1) differentiated between instructions versus data, 2) differentiated between operating system MS) versus trusted application (TA), and/or 3) differentiated between respective TAs. Further, a tertiary trust (or protected) system runs from DRAM, with encryption that is 1) separated from the secondary or highest trust CPUs, 2) differentiated between instructions versus data, 3) differentiated between OS vs TA, and/or 4) differentiated between TAs.

Although the above discussion describes the highest trust element executing from internal SRAM or ROM, it is appreciated that the subject technology can include a highest trust CPU that executes externally to the SoC or chip as well, or other CPUs that could execute from SRAM.

In one or more implementations, for each trusted or protected CPUs/systems, one or more (or all) instruction and data stages may be protected when outside the chip (e.g., the IC chip or system on chip implementing the system described herein), This includes all stages as described in the following: 1) instructions and data stored in external non-volatile memory, 2) input instructions and data stored in DRAM or another external execution device, 3) intermediate data buffers in DRAM or other external execution device, and 4) output instructions and data stored in DRAM or other external execution device.

In an example, encrypting the data and/or instructions of the TAs in a different manner from data and/or instructions of the kernel (e.g., part of the OS running on the system) may prevent the TA from spying or snooping the kernel's code by reading it in as data. If spying or snooping is attempted, the kernel's code may be decrypted incorrectly (or not at all), and therefore would not be visible. Individual TAs are encrypted differently from each other to cover a case where TAs may belong to different parties, and where there is a desire to prevent TAs from spying trusted code of other TAs.

As used herein, “differentiated encryption” can refer to differentiation by encryption algorithm, differentiation by key within the same algorithm, or differentiation by any other variation (e.g., modifying parameters of an encryption algorithm such as padding or substitution-box values).

By differentiating the varying layers of software, and ensuring that all external buffers are encrypted, the subject technology may ensure the following occurs: 1) the trusted execution environment (TEE) codeset (which includes all trusted CPUs) is not available in the dear when stored or executing externally to the chip in which the CPU resides, 2) lower trust level CPUs/TAs may not spy/snoop the code or data of higher trust level CPUs/TAs, 3) individual TAs in the same layer may not spy/snoop the code of other TAs in the same layer (which may belong to different parties), 4) intermediate buffers or other buffers which may give some insight into the TEE operation, are never exposed externally, and 5) other SOC clients may not see any part of the TEE code/data, even if other protection mechanisms fail.

Thus, for any user with applications using security CPUs or TAs in multiple security layers, the described system may provide a chain-of-protection between security layers, i.e., between CPUs or TAs of different trust levels. For different users with TAs in the same layer, the described system may provide a strong cryptography separation which is an added redundancy from MMU protection within the CPU.

Within a processor, the chain of protection can be used similarly to (and redundantly with) the MMU, in the sense that different pieces of code can be isolated from each other by different algorithms/keys. However, this may be stronger than MMU separation (e.g., providing separate memory regions for the different pieces of code), because 1) the protection spans CPUs, meaning that a higher trust CPU (e.g., one in a higher security layer than at least one other security layer) guarantees the security of a lower security CPU (e.g., one in a lower security layer from the higher trust CPU), which may not be possible with MMU, which only operates on a single CPU and cannot span multiple entities, and 2) the decryption algorithm and key is not known to the CPU firmware being protected at least because the key and algorithm are programmed by a completely separate CPU, and are implemented in hardware that is not accessible to software of the target CPU, and therefore, unlike with an MMU, a software exploit on the CPU itself cannot modify the protections.

FIG. 3 illustrates an example system for providing different layers of instructions and data that are encrypted differently in accordance with one or more implementations. Not all of the depicted components may be used, however, and one or more implementations may include additional components not shown in the figure. Variations in the arrangement and type of the components may be made without departing from the spirit or scope of the claims as set forth herein. Additional components, different components, or fewer components may be provided. In an implementation, the example system of FIG. 3 may be implemented by the electronic device 104, and may include suitable logic, circuitry, and/or code that implement the functionality described herein. In some implementations, encryption of code and data may be utilized in place of authentication by each processor or CPU in the system. In some other implementations, code (e.g., instructions) and data encryption may be utilized in conjunction with authentication by each processor or CPU in the system.

FIG. 3 illustrates differing layers of instructions and data that are encrypted differently, and that externally stored instructions or data are encrypted differently. In the discussion of FIG. 3, the term “encryption” can be swapped with “decryption” or “scrambling” or “descrambling” without affecting the scheme as decrypting clear data can garble (e.g., obscure) such data in the same way as encryption.

As illustrated, the system of FIG. 3 includes a chip 301 (e.g., an IC chip or SoC). The chip 301 may include suitable logic, circuitry, and/or code that may implement the functionality described herein. The chip 301 includes a trusted CPU 305 in the example of FIG. 3, where the trusted CPU 305 corresponds to a particular layer of security (e.g., a higher layer from at least one other lower layer) provided in the system.

The system includes a flash or NVM 304 storing original code and data for an OS and various TAs. In an implementation, code and data that is stored externally is encrypted. For example, code and data stored in flash or NVM 304 may be encrypted with a particular encryption method (“Encryption Method 0”), A trusted DMA with decryption component 303 is provided that can decrypt the encrypted code and data from the flash or NVM 304 for storing in DRAM 302.

As shown, the DRAM 302 stores respective data and instructions corresponding to the OS and various TAs. For example, the DRAM 302 stores OS data 320, OS instructions 324, trusted application TA1 data 326, trusted application TA1 instructions 328, trusted application TA2 data 330, trusted application TA2 instructions 332, and stores respective instructions and data for up to N number of trusted applications (e.g., as shown by instructions 334 for trusted application TAN). Further, the DRAM 302 stores information in an intermediate buffer 336 and an output buffer 338, where the information includes output data provided by the trusted CPU 305 from processing instructions and/or data from the OS or a particular TA.

The chip 301 includes one or more cryptographic elements that provide various encryption/decryption methods that may implement various cryptographic algorithms for encryption and decryption of information stored (or to be stored) on the DRAM 302. As utilized herein, the term “method” when used in conjunction with “encryption” or “decryption” (eg., encryption method, decryption method) refers to an algorithm(s) or techniques for performing encryption or decryption based on, for example, a given cryptographic key and/or various cryptographic parameters.

In this regard, the chip 301 provides respective encryption and decryption methods 340, 344, and 348 for encryption of data to be stored in the DRAM 302 and decryption of data read from the DRAM 302. The respective encryption and decryption methods 340, 344, and 348 may be implemented by hardware, e.g. a cryptographic processor and/or firmware/software. Each respective data and each respective instructions stored in the DRAM 302 and the NVM 304, as shown in the example of FIG. 3, are encrypted and/or decrypted differently (e.g., based on different cryptographic algorithms and/or different cryptographic parameters). Thus, it is appreciated that the system ensures that the respective data and respective instructions are in an encrypted form when stored externally to the chip 301 (e.g., in the NVM 304, the DRAM 302, or any other external device) such that any devices outside the chip 301 can only view this data in an encrypted form. When encrypted in DRAM, the data and instructions are only readable or writeable by authorized and authenticated processes when executing in a security processor (e.g., the trusted CPU 305).

Further, the chip 301 provides respective decryption methods 342, 346, 350, and 352 for decryption of data read from the DRAM 302. As illustrated, the chip 301 includes encryption and decryption method 354 for encryption and decryption of data to be stored in or read from the intermediate buffer 336, and encryption and decryption method 356 for encryption and decryption of data to be stored in the output buffer 338. Output data from executing decrypted instructions from one or more trusted applications are encrypted when stored externally from the chip 301 (e.g., in the NVM 304, the DRAM 302, or any other external device) such that the encrypted output data can only be decrypted and used by the authorized and authenticated processing element(s) (e.g., such as a trusted CPU) inside or outside the chip 301.

FIG. 4 illustrates an example system including various components to provide differentiated encryption in accordance with one or more implementations. Not all of the depicted components may be used, however, and one or more implementations may include additional components not shown in the figure. Variations in the arrangement and type of the components may be made without departing from the spirit or scope of the claims as set forth herein. Additional components, different components, or fewer components may be provided. In an implementation, the example system of FIG. 4 may be implemented by the electronic device 104 and may include suitable logic, circuitry, and/or code that implement the functionality described herein.

In an implementation, the system utilizes particular hardware in the CPU execution pipe to decrypt instructions and data, where this hardware is configured by a higher trust entity (e.g., higher trust CPU in a security layer that is higher than at least one other security layer). However, it is appreciated that this approach may also utilize software decryption of instructions and data in conjunction with the hardware.

The example system in FIG. 4 may include one or more hardware components that provides: 1) process identifiers (IDs) of individual processes on the CPU (including the kernel) which are brought out to the bus and can affect the decryption, 2) data and instruction hardware (HW) indicators, which can be used to differentiate data and instructions in order to apply different decryption to the data and instructions, and 3) range registers (e.g., address range registers 415) which provide address ranges, whereby each address range may receive a separate and/or different encryption.

As shown, the system includes DRAM 440 that includes various processes that may be encrypted differently including process 450, process 454, and up to an N number of processes indicated by a process 454. Each of the processes in the DRAM 440 may correspond to a particular and/or different trusted application, which may be stored in a particular address range.

In an implementation, a higher trust CPU 405 determines a particular address range in the DRAM 440 corresponding to each of the processes in the DRAM 440, which the higher trust CPU 405 may store in address range registers 415. The higher trust CPU 405 may also provide base key or cryptographic parameters 417 to a logical resolution component 420. The logical resolution component 420 may include suitable logic, circuitry, and/or code that may implement the functionality described herein. In this example, the higher trust CPU 405, associated with a higher security layer, is responsible for ensuring the protection (i.e., code/data encryption) of lower security layers by writing cryptographic parameters (e.g., keys or other data to the instruction/data cryptography hardware of a lower trusted component.

In one or more implementations, the higher trust CPU 405 can provide base key or cryptographic parameters 417 through any set of appropriate signals, as long as these signals are not visible to software of any lower trust entity. In an example, the system provides a standard register bus that is privatized, so that other CPUs do not see values traveling on the bus. The higher trust CPU writes the values to the hardware of the lower trust element, in the same way the higher trust CPU can write values to any other register. In this example, the hardware being written to is physically connected to the privatized bus.

In an implementation, a cryptographic element 430 receives encrypted code or data 433 from one of processes in the DRAM 440. The cryptographic element 430 may utilize the keys or other cryptographic parameters 422 to decrypt the encrypted code or data 433 and provide clear code or data 424 (e.g., decrypted instructions or data) that is stored in a cache 425.

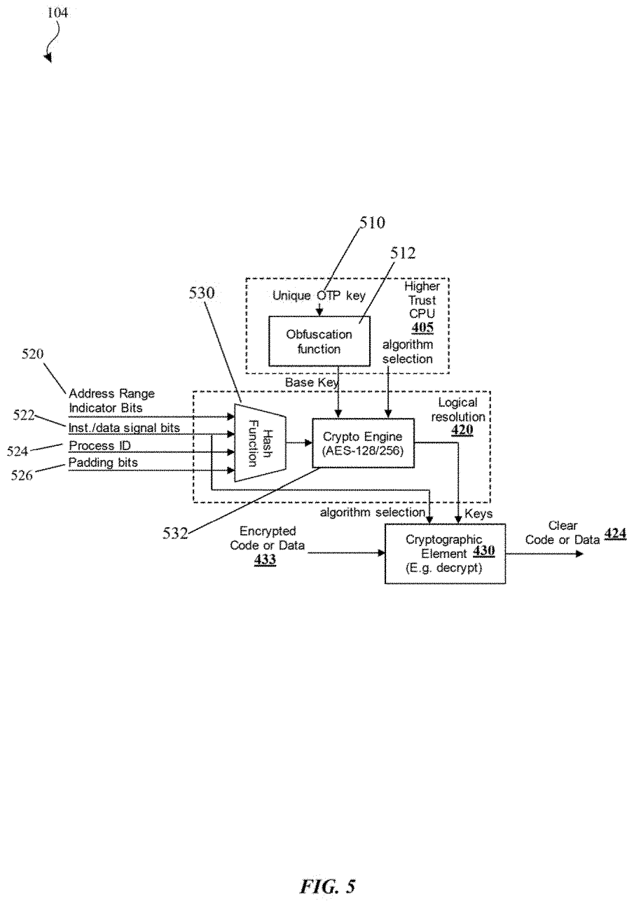

The system includes a trusted CPU 410 which provides a process ID 414. Individual process IDs or other unique process-based indicators are utilized by the system to enforce, in hardware, that decryption is different for different software processes (including kernel or OS related processes). In an implementation, the trusted CPU 410 is configured to provide an ID of each process that is currently running on the system and a signal 412 indicating whether instruction or data is to be decrypted. The system further utilizes the signal 412, indicating either instruction or data, to enforce that that data and instructions are decrypted utilizing different decryption methods. Based at least in part on the process ID 414, the signal 412, the base key or cryptographic parameters 417, and/or address range information from the address range registers 415, the logical resolution component 420 can provide keys or other cryptographic parameters 422 to the cryptographic element 430 for decrypting encrypted code or data 433. A more detailed discussion with respect to implementations in connection with the logical resolution component 420 is described below in FIG. 5.

In an implementation, the base key comes from a high-quality RNG (e.g., hardware random number generator), and will be different for each address range simply because the base key is read out at different times (the RNG produces different numbers with every read). It is possible to further uniquify the key by hashing this random number together with the address range registers 415, or perform an XOR on the random number with the address range registers 415. An instruction/data signal (e.g., the signal 412) can be used to XOR a different set of bits into the key, so that decryption of instructions uses a different key than decryption of data. For example, instructions may use the base key with an address hashed in, while data uses this same base key XORed with a given constant value. Because of the nature of AES and other modern cryptographic algorithms, changing a single bit in the key will produce completely different ciphertext and/or output. A single key can include several elements merged together: 1) a random number from the RNG, 2) address values which are XORed or hashed into this random number, and 3) a secret constant which is XORed or not, based on the instruction data signal (e.g., the signal 412) from the trusted CPU 410.

In an implementation, the value of the RNG changes for every read, and so will also be different for every boot cycle. Consequently, keys based on the random number change on every boot cycle, which facilitates better security on the system.

If the RNG is utilized for generating the base key as discussed above, the following discussion relates to how data gets from a NVM (e.g., the NVM 304) to a final encrypted stage in DRAM (e.g., DRAM 302). After being stored in DRAM, the RNG is initially utilized in some implementations.

In an example, initially, code is encrypted in flash (e.g., the NNW 304) with a key/algorithm that may be different than utilized elsewhere in the system. To do this securely, an encrypted blob (e.g., binary data) in flash ha to be written to DRAM, and then in-line decrypted/re-encrypted with a final cryptographic algorithm. In an example, this “in-line” decryption occurs inside the chip hardware (e.g., the chip 301), so that the clear code/data is not exposed to any untrusted element. During this re encryption part, a final encryption key is generated using the RNG and address range, since this key is used to encrypt the data in DRAM. The final encryption key is then saved and written to the decryption HW (e.g., the cryptographic element 430) in the CPU.

The above discussion is accomplished, in some implementations, with the following steps:
1) a CPU reads encrypted code/data from flash, writes to DRAM (this can be performed by an untrusted CPU since data is encrypted). In an example, this flash data is encrypted with a particular algorithm/key which is not related to other algorithms/keys discussed herein;
2) The (possibly untrusted) CPU commands a higher trust element (e.g., the higher trust CPU 405) to transcrypt the data into the final DRAM format;
3) The higher trust element (e.g., the higher trust CPU 405) reads from a RNG and creates a final encryption key using the method described above;
4) The higher trust element (e.g., the higher trust CPU 405) reads the lash-encrypted data from DRAM, and passes the data through a hardware transcryptor. This transcryptor decrypts using the flash algorithm previously used to encrypt the flash data, re-encrypts with a final DRAM algorithm (using the final encryption key created in the previous step), and passes the re-encrypted data hack out to DRAM.
5) The higher trust element (e.g., the higher trust CPU 405) now saves the key that was used in the final encryption step, and writes this key to the decryption hardware of the targeted CPU (i.e. the one whose instructions/data are to be decrypted);
6) At this point, the targeted CPU may execute from encrypted instructions in DRAM.

Further, the use of a RNG as discussed above is an example, and a key can be created by any other techniques, including utilizing a pseudo-RNG, or any other appropriate methodology and technique(s).

As mentioned above, the clear code or data 424 (e.g., decrypted instructions or data) may be stored in the cache 425, which is then provided to an execution pipe of the trusted CPU 410 for executing or processing. In an example, output data as a result from processing the clear code or data 424 may be encrypted and stored in a particular memory device (e.g., the DRAM 440, the NVM 304, or another external memory device).

FIG. 5 illustrates an example logical resolution function including various components in accordance with one or more implementations. Not all of the depicted components may be used, however, and one or more implementations may include additional components not shown in the figure. Variations in the arrangement and type of the components may be made without departing from the spirit or scope of the claims as set forth herein Additional components, different components, or fewer components may be provided. In an implementation, the example logical resolution function may be implemented by the electronic device 104 and may include suitable logic, circuitry, and/or code that implement the functionality described herein. FIG. 5 will be discussed in reference to portions of FIG. 4, for example, specifically with respect to the higher trust CPU 405, the logical resolution component 420, and the cryptographic element 430, among other components.

The subject technology may provide one or more implementations to generate the base key or cryptographic parameters 417. For example, 1) a base key may be generated in the higher trust CPU by deriving it from a unique-per-chip OTP root key 510, and 2) the cryptographic algorithm in the logical resolution component 420 may also be selected by the higher trust CPU 405.

The subject technology may provide one or more implementations for the logical resolution functionality (e.g., as provided by the logical resolution component 420). For example, 1) address range indicator bits 520, instruction/data signal bits 522, and a process ID 524 may be used as inputs for a hash function 530 to generate an input for a cryptographic engine 532, 2) the algorithm selection from the higher trust CPU 405 determines the cryptographic algorithm being used, 3) the base key is the key for the cryptographic algorithm, 4) the output of this cryptographic engine 532 is the key for the cryptographic element 430 (e.g., decryption), and 5) instruction/data signal bits 522 may be used to modify the decryption or select the algorithm. Based on the algorithm selection and the base key, the cryptographic element 430 can decrypt the encrypted code or data 433 and provide the clear code or data 424.

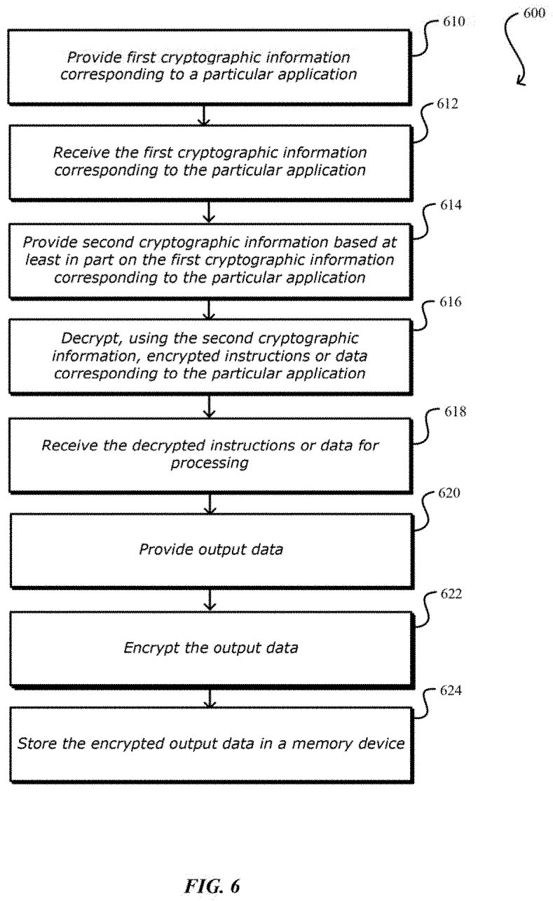

FIG. 6 conceptually illustrates an example flowchart of a process 600 performed by the electronic device 104 for decrypting instructions and/or data from a trusted application in accordance with some implementations. However, the process 600 is not limited to the electronic device 104 and may be performed by any suitable device and/or one or more different components of the electronic device 104. Although this figure, as well as other process illustrations contained in this disclosure may depict functional steps in a particular sequence, the processes are not necessarily limited to the particular order or steps illustlated. The various steps portrayed in this, or other figures can be changed, rearranged, performed in parallel or adapted in various ways. Furthermore, it is to be understood that certain steps or sequences of steps can be added to or omitted from the process, without departing from the scope of the various implementations.

The electronic device 104 provides first cryptographic information corresponding to a particular application, the first cryptographic information including a base key or a set of cryptographic parameters (610). In an implementation, a volatile memory device (e.g., DRAM 440 or DRAM 302) stores instructions and data corresponding to a plurality of processes (e.g., processes 450, 452, and 454), and each of the processes corresponds to a particular application (e.g., trusted applications in FIG. 3, or one of the processes 450, 452, and 454) executing on the electronic device 104. Each of the processes from the volatile memory device may be unable to decrypt instructions or data. Moreover, in an implementation, a first processor (e.g., a higher trust CPU 405) associated with a first security layer provides first cryptographic information corresponding to the particular application where the first cryptographic information includes a base key or a set of cryptographic parameters.

The electronic device 104 receives the first cryptographic information corresponding to the particular application (612). In an implementation, a logical resolution component (e.g., the logical resolution component 420) receives the first cryptographic information corresponding to the particular application.

The electronic device 104 provides second cryptographic information based at least in part on the first cryptographic information corresponding to the particular application, an indication of an instruction or data, and a process identifier (ID) of the particular application (614). In an example, the second cryptographic information corresponding to the particular application is different than respective cryptographic information corresponding to a different application. In an implementation, the logical resolution component (e.g., the logical resolution component 420) provides second cryptographic information based at least in part on the first cryptographic information corresponding to the particular application, an indication of an instruction or data, and a process identifier (ID) of the particular application. In an implementation, the second cryptographic information is derived from the address range (and/or process identifier) and the first cryptographic information, such as by hashing the first cryptographic information with the memory range and/or the process identifier. In this manner, the electronic device 104 is further configured to utilize respective process identifiers to enforce different decryption methods for different processes in which the different processes includes at least one operating system process and at least one application process.

The electronic device 104 decrypts, using the second cryptographic information, encrypted instructions or data corresponding to the particular application to provide decrypted instructions or data (616). In an implementation, a cryptographic element (e.g., the cryptographic element 430) associated with a second security layer decrypts, using the second cryptographic information, encrypted instructions or data corresponding to the particular application to provide decrypted instructions or data.

In an implementation, the encrypted, instructions or data corresponding to the particular application are received from the volatile memory device (e.g., the DRAM 440). In an example, the instructions and the data corresponding to the plurality of processes stored in the volatile memory device are prevented (e.g., through cryptography), from accessing instructions of other processes, and each process from the plurality of processes, the first processor (e.g., the higher trust CPU 405), the logical resolution component (e.g., the logical resolution component 420), and the second processor (e.g., the trusted CPU 410) are cryptographically isolated from each other.

In one or more implementations, the encrypted instructions or data corresponding to the particular application may be encrypted differently from respective instructions or data of another application or process. The encrypted instructions corresponding to the particular application may be encrypted differently from the encrypted data corresponding to the particular application. Each process included in a same security layer may be encrypted differently to each other process in the same security layer. Further, each security layer may be encrypted differently to each other security layer.

In an example, the encrypted instructions or data corresponding to the particular application may be encrypted differently based on at least one of a different encryption algorithm different key, different modification to the different encryption algorithm, different padding, different substitution-box, different parameter, or using decryption to obscure particular decrypted instructions. Further, it is appreciated that each of the instructions and the data corresponding to each process utilize different decryption methods. It is further appreciated that code corresponding to the first processor (e.g., the higher trust CPU) or the second processor (e.g., the trusted CPU 410), when stored externally in a particular memory device, is encrypted, where the code is executable by an authorized process (e.g., trusted application) based on run-time decryption and authentication of the code.

The electronic device 104 receives the decrypted instructions or data for processing (618). In an implementation, a second processor (e.g., the trusted CPU 410 or the trusted CPU 305) associated with the second security layer receives the decrypted instructions or data for processing.

Further, the electronic device 104 provides output data (620). The electronic device 104 encrypts the output data (622). Further, the electronic device stores the encrypted output data on a memory device (624), In implementation, a trusted CPU (e.g., the trusted CPU 410 or the trusted CPU 305) provides the output data after processing the decrypted instructions or data, encrypts the output data, and stores the encrypted output data to an external memory device (e.g., DRAM 440 or DRAM 302).

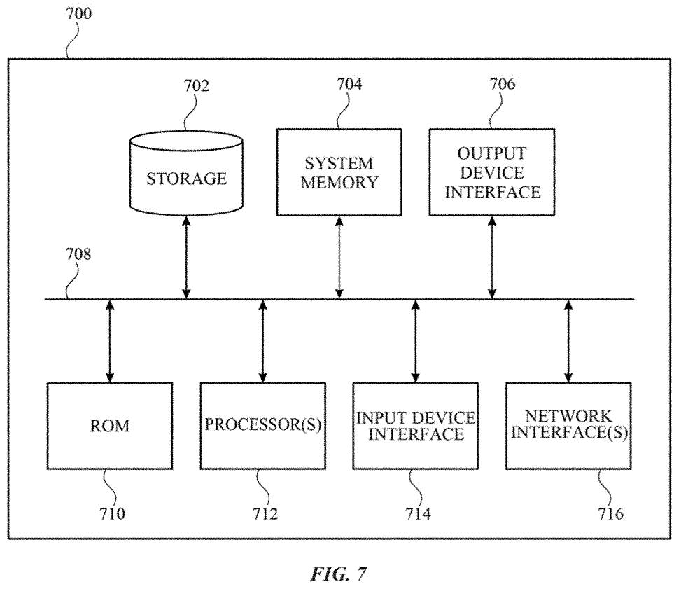

FIG. 7 illustrates an electronic system 700 with which one or more implementations of the subject technology may be implemented. The electronic system 700 can be, and/or can be a part of, the electronic device 104, and/or the server 102 shown in FIG. 1. The electronic system 700 may include various types of computer readable media and interfaces for various other types of computer readable media. The electronic system 700 includes a bus 708, one or more processing unit(s) 712, a system memory 704 (and/or buffer), a ROM 710, a permanent storage device 702, an input device interface 714, an output device interface 706, and one or more network interfaces 716, or subsets and variations thereof.

The bus 708 collectively represents all system, peripheral, and Chipset buses that communicatively connect the numerous internal devices of the electronic system 700. In one or more implementations, the bus 708 communicatively connects the one or more processing unit(s) 712 with the ROM 710, the system memory 704, and the permanent storage device 702. From these various memory units, the one or more processing unit(s) 712 retrieves instructions to execute and data to process in order to execute the processes of the subject disclosure. The one or more processing unit(s) 712 can be a single processor or a multi-core processor in different implementations.

The ROM 710 stores static data and instructions that are needed by the one or more processing unit(s) 712 and other modules of the electronic system 700. The permanent storage device 702, on the other hand, may be a read-and-write memory device. The permanent storage device 702 may be a non-volatile memory unit that stores instructions and data even when the electronic system 700 is off. In one or more implementations, a mass-storage device (such as a magnetic or optical disk and its corresponding disk drive) may be used as the permanent storage device 702.

In one or more implementations, a removable storage device (such as a floppy disk, flash drive, and its corresponding disk drive) may be used as the permanent storage device 702. Like the permanent storage device 702, the system memory 704 may be a read-and-write memory device. However, unlike the permanent storage device 702, the system memory 704 may be a volatile read-and-write memory, such as random access memory. The system memory 704 may store any of the instructions and data that one or more processing unit(s) 712 may need at runtime. In one or more implementations, the processes of the subject disclosure are stored in the system memory 704, the permanent storage device 702, and/or the ROM 710. From these various memory units, the one or more processing unit(s) 712 retrieves instructions to execute and data to process in order to execute the processes of one or more implementations.

The bus 708 also connects to the input and output device interfaces 714 and 706. The input device interface 714 enables a user to communicate information and select commands to the electronic system 700. Input devices that may be used with the input device interface 714 may include, for example, alphanumeric keyboards and pointing devices (also called “cursor control devices”). The output device interface 706 may enable, for example, the display of images generated by electronic system 700. Output devices that may be used with the output device interface 706 may include, for example, printers and display devices, such as a liquid crystal display (LCD), a light emitting diode (LED) display, an organic light emitting diode (OLED) display, a flexible display, a flat panel display, a solid state display, a projector, or any other device for outputting information. One or more implementations may include devices that function as both input and output devices, such as a touchscreen. In these implementations, feedback provided to the user can be any form of sensory feedback, such as visual feedback, auditory feedback, or tactile feedback; and input from the user can be received in any form, including acoustic, speech, or tactile input.

Finally, as shown in FIG. 7, the bus 708 also couples the electronic system 700 to one or more networks and/or to one or more network nodes, such as the electronic device 104 shown in FIG. 1, through the one or more network interface(s) 716. In this manner, the electronic system 700 can be a part of a network of computers (such as a LAN, a wide area network (“WAN”), or an Intranet, or a network of networks, such as the Internet. Any or all components of the electronic system 700 can be used in conjunction with the subject disclosure.

Implementations within the scope of the present disclosure can be partially or entirely realized using a tangible computer-readable storage medium (or multiple tangible computer-readable storage media of one or more types) encoding one or more instructions. The tangible computer-readable storage medium also can be non-transitory in nature.

The computer-readable storage medium can be any storage medium that can be read, written, or otherwise accessed by a general purpose or special purpose computing device, including any processing electronics and/or processing circuitry capable of executing instructions. For example, without limitation, the computer-readable medium can include any volatile semiconductor memory, such as RAM, DRAM, SRAM, T-RAM, Z-RAM, and TTRAM. The computer-readable medium also can include any non-volatile semiconductor memory, such as ROM, PROM, EPROM, EEPROM, NVRAM, flash, nvSRAM, FeRAM, FeTRAM, MRAM, PRAM, CBRAM, SONOS, RRAM, NRAM, racetrack memory, FJG, and Millipede memory.

Further, the computer-readable storage medium can include any non-semiconductor memory, such as optical disk storage, magnetic disk storage, magnetic tape, other magnetic storage devices, or any other medium capable of storing one or more instructions. In some implementations, the tangible computer-readable storage medium can be directly coupled to a computing device, while in other implementations, the tangible computer-readable storage medium can be indirectly coupled to a computing device, e.g., via one or more wired connections, one or more wireless connections, or any combination thereof.

Instructions can be directly executable or can be used to develop executable instructions. For example, instructions can be realized as executable or non-executable machine code or as instructions in a high-level language that can be compiled to produce executable or non-executable machine code. Further, instructions also can be realized as or can include data. Computer-executable instructions also can be organized in any format, including routines, subroutines, programs, data structures, objects, modules, applications, applets, functions, etc. As recognized by those of Skill in the art, details including, but not limited to, the number, structure, sequence, and organization of instructions can vary significantly without varying the underlying logic, function, processing, and output.

While the above discussion primarily refers to microprocessor or multi-core processors that execute software, one or more implementations are performed by one or more integrated circuits, such as application specific integrated circuits (ASICs) or field programmable gate arrays (FPGAs). In one or more implementations, such integrated circuits execute instructions that are stored on the circuit itself.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

It is understood that any specific order or hierarchy of blocks in the processes disclosed is an illustration of example approaches. Based upon design preferences, it is understood that the specific order or hierarchy of blocks in the processes may be rearranged, or that all illustrated blocks be performed. Any of the blocks may be performed simultaneously. In one or more implementations, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

As used in this specification and any claims of this application, the terms “base station”, “receiver”, “computer”, “server”, “processor”, and “memory” all refer to electronic or other technological devices. These terms exclude people or groups of people. For the purposes of the specification, the terms “display” or “displaying” means displaying on an electronic device.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The predicate words “configured to”, “operable to”, and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration.” Any embodiment described herein as “exemplary” or as an “example” is not necessarily to be construed as preferred or advantageous over other embodiments. Furthermore, to the extent that the term “include,” “have,” or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.”

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

What s claimed is:

1. A system configured to provide multiple security layers, the system comprising:
a volatile memory device storing instructions and data corresponding to a plurality of processes, each of the processes comprising a particular application executing on the system;
a first processor associated with a first security layer, the first processor configured to:
provide first cryptographic information corresponding to the particular application, the first cryptographic information including a base key or a set of cryptographic parameters;
a logical resolution circuit, the logical resolution circuit configured to:
receive the first cryptographic information corresponding to the particular application;
provide second cryptographic information based at least in part on the first cryptographic information corresponding to the particular application, an indication of an instruction or data, and a process identifier (ID) of the particular application;
a cryptographic element associated with a second security layer, the cryptographic element configured to:
decrypt, using the second cryptographic information, encrypted instructions or data corresponding to the particular application to provide decrypted instructions or data; and
a second processor associated with the second security layer, the second processor configured to:
receive the decrypted instructions or data for processing,

2. The system of claim 1, wherein each of the processes from the volatile memory device is unable to decrypt encrypted instructions or data.

3. The system a claim 1, wherein the second cryptographic information corresponding to the particular application is different than respective cryptographic information corresponding to a diff rent application.

4. The system of claim 3, wherein the encrypted instructions or data corresponding to the particular application are encrypted differently from respective instructions or data of another application or process,
wherein the encrypted instructions corresponding to the particular application are encrypted differently from the encrypted data corresponding to the particular application,
wherein each process included in a same security layer is encrypted differently to each other process in the same security layer, and
wherein each security layer is encrypted differently to each other security layer.

5. The system of claim 4, wherein the encrypted instructions or data corresponding to the particular application is encrypted differently based on at least one of a different encryption algorithm, different key, different modification to the different encryption algorithm, different padding, different substitution-box, different parameter, or using decryption to obscure particular decrypted instructions.

6. The system of claim 1, wherein the instructions and the data corresponding to the plurality of processes stored in the volatile memory device are prevented through cryptography, from accessing instructions of other processes, and each process from the plurality of processes, the first processor, the logical resolution circuit, and the second processor are cryptographically isolated from each other.

7. The system of claim 1, wherein the logical resolution circuit is further configured to utilize respective process identifiers to enforce different decryption methods for different processes, the different processes including at least one operating system process and at least one application process.

8. The system of claim 1, wherein each of the instructions and the data corresponding to a given process utilize different decryption methods.

9. The system of claim 1, wherein each processor in the system utilizes encryption in addition to authentication of code.

10. The system of claim 1, wherein code corresponding to the first processor or the second processor, when stored externally in a particular memory device, is encrypted, the code being executable by a trusted process based on run-time decryption and authentication of the code.

11. The system of claim 1, wherein a first application in a lower trusted component is unable to access code or data of another application in the lower trusted component.

12. The system of claim 1, further comprising:
a non-volatile memory device, the non-volatile memory device storing respective instructions and data for different applications, the respective instructions and data of each of the different applications being encrypted differently from each other.

13. The system of claim 1, wherein the second processor is further configured to:
provide output data based on the decrypted instructions or data;
encrypt the output data; and
store the encrypted output, data in an external memory device.

14. A method comprising:
identifying first cryptographic information corresponding to a particular application, the first cryptographic information including a base key or a set of cryptographic parameters;
providing second cryptographic information based at least in part on the first cryptographic information corresponding to the, particular application, an indication of an instruction or data, and a process identifier (ID) of the, particular application;
decrypting, using the second cryptographic information, encrypted instructions or data corresponding to the particular application to provide decrypted instructions or data; and
receive the decrypted instructions or data for processing.

15. The method of claim 14, wherein the second cryptographic information corresponding to the particular application is different than respective cryptographic information corresponding to a different application.

16. The method of claim 14, wherein the encrypted instructions or data corresponding to the particular application are encrypted differently from respective instructions or data of another application or process,
wherein the encrypted instructions corresponding to the particular application is encrypted differently from the encrypted data corresponding to the particular application,
wherein each process included in a same security layer is encrypted differently to each other process in the same security layer, and
wherein each security layer is encrypted differently to each other security layer.

17. The method of claim 14, wherein the encrypted instructions or data corresponding to the particular application is encrypted differently based on at least one of a different encryption algorithm, different key, different modification to the different encryption algorithm, different padding, different substitution-box, different parameter, or using decryption to obscure particular decrypted instructions.

18. The method of claim 14, wherein instructions and data corresponding to a plurality of processes are stored on a volatile memory device, and the instructions and the data corresponding to the plurality of processes are prevented through cryptography, from accessing instructions of other processes, and each process from the plurality of processes are cryptographically isolated from each other.

19. The method of claim 14, further comprising:
providing output data based on the decrypted instructions or data;
encrypting the output data; and
storing the encrypted output data in an external memory device.

20. A device comprising:
a logical resolution circuit configured to:
receive, from a first processor associated with a first security layer, first cryptographic information corresponding to a particular application; and
provide, to a cryptographic circuit associated with a second security layer that is lower Man the first security layer, second cryptographic information that is determined based on one or more of: the first cryptographic information corresponding to the particular application, an indication of an instruction or data, or a process identifier (ID) of the particular application; and
the cryptographic circuit configured to:
decrypt, using the second cryptographic information, encrypted instructions or data corresponding to the particular application to provide decrypted instructions or data; and
provide, to a second processor associated with the second security laver, the decrypted instructions or data for processing.
